(19) United States
(12) Patent Application Publication
(10) Pub. No.: US 2023/0186197 A1
(43) Pub. Date: Jun. 15, 2023

(54) EFFECTIVE PERFORMANCE ASSESSMENT

(71) Applicant: International Business Machines Corporation, Armonk, NY (US)

(72) Inventors: Rakesh Rameshrao Pimplikar, Bangalore (IN); Sameep Mehta, Bangalore (IN); Nazia Hasan, Bangalore (IN); Varun Gupta, Larchmont, NY (US); Kingshuk Banerjee, Bangalore (IN)

(21) Appl. No.: 17/550,143

(22) Filed: Dec. 14, 2021

(51) Int. Cl. G06Q 10/06; G06F 16/93; G06N 20/00

(52) U.S. Cl. CPC G06Q 10/063118; G06Q 10/06393; G06F 16/93; G06N 20/00

(57) ABSTRACT

In an approach for effective performance assessment, a processor classifies relevancy of a goal submitted by an employee. A processor classifies the goal into one of pre-defined dimensions. A processor receives feedback about the goal from a manager. A processor classifies whether the feedback is actionable with respect to the corresponding goal. A processor classifies consistency of the feedback with the corresponding dimension of the goal. A processor classifies consistency of the feedback with the corresponding position level of the employee. A processor converts the feedback along the corresponding dimension into a rating for the dimension on a pre-defined scale.

### BACKGROUND

The present disclosure relates generally to the field of machine learning, and more particularly to effective performance assessment.

Artificial intelligence, sometimes also referred to as machine intelligence, refers to a broad set of methods, algorithms, and technologies that enable systems, either in software or embodied forms, to display aspects of intelligent behavior in a way that may seem human-like to an outside observer. As a part of augmented intelligence and artificial intelligence, machine learning refers to a wide variety of algorithms and methodologies that enable systems to improve the system's performance over time as machine learning obtains more data and learns from the data. Essentially, machine learning is about recognizing trends from data or recognizing the categories that the data fits in so that when the machine-learned system is presented with new data, the machine-learned system can make proper predictions. Machine learning systems train under supervision, learning from examples and feedback, or in unsupervised mode. Machine learning techniques can span a wide array of architectures, models, and techniques including neural networks, deep learning, support vector machines, decision trees, self-organizing maps, case-based reasoning, instance-based learning, hidden Markov models, and regression techniques.

### SUMMARY

Aspects of an embodiment of the present disclosure disclose an approach for effective performance assessment. A processor classifies relevancy of a goal submitted by an employee. A processor classifies the goal into one of pre-defined dimensions. A processor receives feedback about the goal from a manager. A processor classifies whether the feedback is actionable with respect to the corresponding goal. A processor classifies consistency of the feedback with the corresponding dimension of the goal. A processor classifies consistency of the feedback with the corresponding position level of the employee. A processor converts the feedback along the corresponding dimension into a rating for the dimension on a pre-defined scale.

### BRIEF DESCRIPTION OF THE DRAWINGS

FIG. 1 is a functional block diagram illustrating a performance assessment environment, in accordance with an embodiment of the present disclosure.

FIG. 2 is a flowchart depicting operational steps of a performance assessment analytics within a computing device of FIG. 1, in accordance with an embodiment of the present disclosure.

FIG. 3 illustrates an exemplary functional diagram of the performance assessment analytics within the computing device of FIG. 1, in accordance with an embodiment of the present disclosure.

FIG. 4 is a block diagram of components of the computing device of FIG. 1, in accordance with an embodiment of the present disclosure.

### DETAILED DESCRIPTION

The present disclosure is directed to systems and methods for effective performance assessment.

Embodiments of the present disclosure recognize a need for periodic assessment systems for appraisals instead of one-shot year-end assessment. Every employee may be assessed based on certain dimensions instead of getting a single rating. These dimensions may be pre-specified by an organization. Periodic assessments may be effective if employees set reasonable goals and managers provide timely and actionable feedbacks. A human resource manager or a higher authority may timely intervene to do course correction if an engagement level within a team falls below an acceptable level.

Embodiments of the present disclosure disclose continuously monitoring goals provided by an employee and raising alarms whenever an inconsistent goal is set with respect to the employee's job role and position level. Embodiments of the present disclosure disclose continuously monitoring feedbacks provided by a manager and raising alarms whenever an unactionable feedback is provided for the employee. Embodiments of the present disclosure disclose continuously monitoring the overall engagement within a team and raising alarms to a human resource manager or a higher authority whenever the engagement score falls below a threshold.

Embodiments of the present disclosure disclose a method to analyze an employee profile, the employee's team projects, job role responsibilities, and position level to classify every goal, which the employee provides, as relevant or irrelevant. Embodiments of the present disclosure disclose a method to classify every goal submitted by an employee into one of the pre-specified dimensions. Embodiments of the present disclosure disclose a method to classify every feedback provided by a manager as actionable or unactionable with respect to the goal. Embodiments of the present disclosure disclose a method to classify every feedback provided by a manager as consistent or inconsistent with the dimension of the goal. Embodiments of the present disclosure disclose a method to classify every feedback as consistent or inconsistent with the position level of the employee. Embodiments of the present disclosure disclose a method to convert feedbacks along a dimension into a rating for that dimension on a pre-specified scale. Embodiments of the present disclosure disclose a method to calculate an engagement score within a team based on the quality of goals provided by employees and the quality of feedbacks provided by the manager.

Embodiments of the present disclosure disclose training an intent identification model separately for every job role with inputs of goals, employee's roles, job role requirements, and employee's projects details, where a responsibility becomes an intent and historically accepted and validated goals against that responsibility become the training text. Embodiments of the present disclosure disclose extracting all the named entities from employee's project details using a named-entity recognition algorithm. Embodiments of the present disclosure disclose extracting all the responsibilities (intents) from job role requirements for the employee's role in the organization, using a simple lookup. Embodiments of the present disclosure disclose classifying the given goal into one of the intents using the trained intent identification model. Embodiments of the present disclosure disclose extracting named entities from the given goal. If the intent of the goal matches with one of the responsibilities (intents) of the employee's role and at least one named entity in the goal belongs to the project entities, the goal may be marked as relevant. Otherwise, the goal may be marked as irrelevant.

Embodiments of the present disclosure disclose training a document classification model with inputs of goals and pre-specified dimensions, where every pre-specified dimension becomes a class label and historically accepted and validated goals against that dimension become the training set. Embodiments of the present disclosure disclose using the trained document classification model to classify the given goal into one of the pre-specified dimensions. Embodiments of the present disclosure disclose marking a feedback as unactionable if the feedback is missing or empty. Embodiments of the present disclosure disclose using natural language processing libraries to check if proper sentences are written. Embodiments of the present disclosure disclose marking a feedback as unactionable if the feedback is just a set of small phrases. Embodiments of the present disclosure disclose extracting predicate-object pairs from the goal and the feedback using part of speech tagging. Embodiments of the present disclosure disclose indicating that the feedback is not relevant if there is no overlap among pairs between the goal and the feedback. Actionable feedbacks may usually have neutral sentiments. If the sentences in the feedback with the overlapping predicate-object pairs are not classified as neutral using sentiment analysis, the feedback may be marked as unactionable.

Embodiments of the present disclosure disclose training a document classification model with inputs of feedbacks and dimensions of the goal, where every pre-specified dimension becomes a class label and historically accepted and validated feedbacks against that dimension become the training set. Embodiments of the present disclosure disclose using the trained document classification model to classify the given feedback into one of the pre-specified dimensions. Embodiments of the present disclosure disclose marking the feedback as consistent with the goal dimension if the assigned dimension label is same as the dimension of the goal.

Embodiments of the present disclosure disclose training an intent identification model separately for every job role, where a responsibility becomes an intent and historically accepted and validated feedbacks against that responsibility become training text. Embodiments of the present disclosure disclose classifying the given feedback into one of the intents using the trained intent identification model. Embodiments of the present disclosure disclose marking the feedback as consistent with the position level of the employee if the intent of the feedback matches with one of the responsibilities (intents) of the employee's role. Embodiments of the present disclosure disclose combining all feedbacks along a dimension to form a document. Embodiments of the present disclosure disclose counting number of sentences with positive, neutral, and negative sentiments. Sentiments may be extracted using sentiment analysis. Embodiments of the present disclosure disclose calculating percentages of positive, neutral, and negative sentiments. Embodiments of the present disclosure disclose training a document classification model for every dimension and every job role, where every rating becomes a class label and documents formed using historically consistent and actionable feedbacks against that rating become the training set. Embodiments of the present disclosure disclose using the trained document classification model to classify the document, which is formed using the given feedbacks, into one of the ratings.

Embodiments of the present disclosure disclose calculating an engagement score within a team based on all the goal-feedback pairs from a team with relevancy score for the goal, a dimension consistency score for the goal, an actionability score for the feedback, a dimension consistency score for the feedback, and a position level consistency score for the feedback.

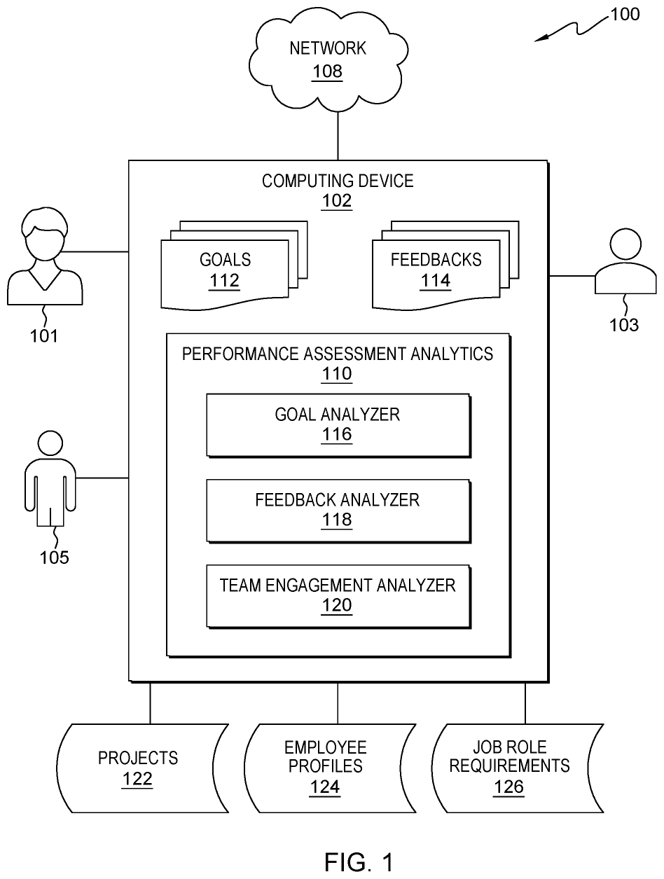

The present disclosure will now be described in detail with reference to the Figures. FIG. 1 is a functional block diagram illustrating a performance assessment environment, generally designated 100, in accordance with an embodiment of the present disclosure.

In the depicted embodiment, performance assessment environment 100 includes computing device 102, projects 122, employee profiles 124, job role requirements 126, and network 108. In the depicted embodiment, projects 122, employee profiles 124, job role requirements 126 are located externally and may be accessed by computing device 102 directly. Projects 122, employee profiles 124 and job role requirements 126 may be accessed through a communication network such as network 108. In other embodiments, projects 122, employee profiles 124, and job role requirements 126 may be located and saved in computing device 102.

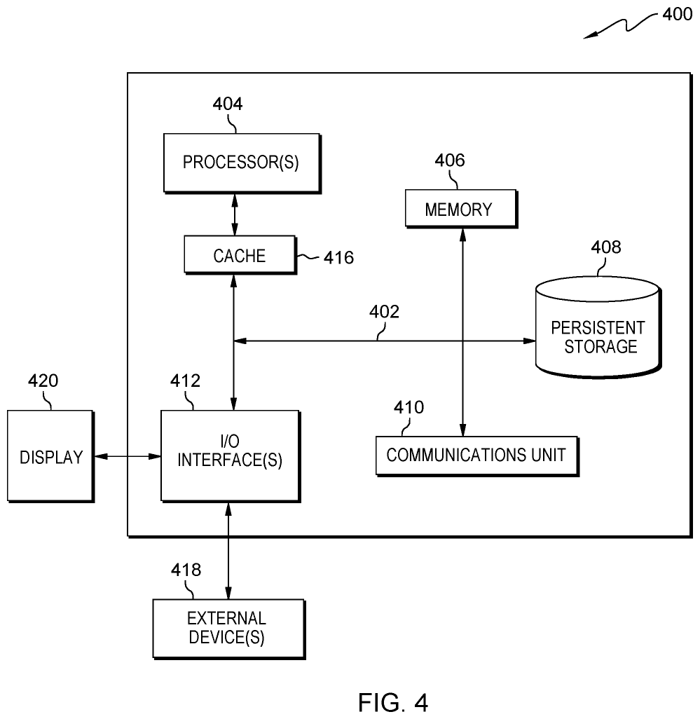

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to performance assessment analytics 110 and network 108 and is capable of processing program instructions and executing performance assessment analytics 110, in accordance with an embodiment of the present disclosure. Computing device 102 may include internal and external hardware components, as depicted and described in further detail with respect to FIG. 4.

Further, in the depicted embodiment, employee 101 may provide goals 112 and manager 103 may provide feedbacks 114. Goals 112 and feedbacks 114 may be located and stored in computing device 102. In other examples, goals 112 and feedbacks 114 may be located externally and accessed through a communication network such as network 108. In the depicted embodiment, computing device 102 includes performance assessment analytics 110. In the depicted embodiment, performance assessment analytics 110 is located on computing device 102. However, in other embodiments, performance assessment analytics 110 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and performance assessment analytics 110, in accordance with a desired embodiment of the disclosure.

In one or more embodiments, performance assessment analytics 110 is configured to classify every goal 112 submitted by employee 101 as relevant or irrelevant, based on an analysis of employee profiles 124, projects 122, job role requirements 126, and a position level associated with employee 101. Performance assessment analytics 110 may analyze employee profiles 124, the employee's team projects 122, job role requirements 126, and the position level of employee 101 to classify every goal 112, which employee 101 provides into an assessment tool, as relevant or irrelevant. Performance assessment analytics 110 may train an intent identification model separately for every job role with inputs of goals 112, employee's roles, job role requirements 126, and employee's details of projects 122, wherein a responsibility becomes an intent and historically accepted and validated goals 112 against that responsibility become the training text. Performance assessment analytics 110 may extract all the named entities from employee's project details using a named-entity recognition algorithm. Performance assessment analytics 110 may extract all the intents from job role requirements 126 for the employee's role in the organization. Performance assessment analytics 110 may classify given goal 112 into one of the intents using the trained intent identification model. Performance assessment analytics 110 may extract named entities from given goal 112. Performance assessment analytics 110 may mark goal 112 as relevant, in response to the intent of goal 112 matching with one of the intents of the employee's role and at least one named entity in goal 112 belonging to the project entities.

In one or more embodiments, performance assessment analytics 110 is configured to classify every goal 112 into one of the pre-defined dimensions. For example, the pre-defined dimensions can be business results, client success, innovation, responsibility to others, skills, or other suitable dimensions which can be defined by an organization. Performance assessment analytics 110 may train a document classification model with inputs of goals 112 and pre-specified dimensions, where every pre-specified dimension becomes a class label and historically accepted and validated goals 112 against that dimension become the training set. Performance assessment analytics 110 may use the trained document classification model to classify the given goal 112 into one of the pre-specified dimensions. Performance assessment analytics 110 may continuously monitor goals 112 provided by employees 101 and may raise alerts whenever an inconsistent goal is set with respect to the employee job role and position level. For example, if performance assessment analytics 110 classifies a goal as inconsistent with the job role, responsibilities, position level, team projects or the assessment dimension, performance assessment analytics 110 may notify employee 101 to consider removing or modifying the goal.

In one or more embodiments, performance assessment analytics 110 is configured to receive one or more feedbacks 114 about employee 101 from manager 103. Performance assessment analytics 110 may classify one or more feedbacks 114 as actionable or unactionable with respect to corresponding goal 112. Performance assessment analytics 110 may mark a given feedback 114 as unactionable if feedback 114 is missing or empty. Performance assessment analytics 110 may use a natural language processing library (e.g., a natural language toolkit in Python) to check if proper sentences are written. If feedback 114 is just a set of small phrases, performance assessment analytics 110 may mark feedback 114 as unactionable. Performance assessment analytics 110 may extract predicate-object pairs from goal 112 and feedback 114 using part of speech tagging. If there is no overlap among pairs from goal 112 and feedback 114, performance assessment analytics 110 may indicate that feedback 114 is not relevant and may mark feedback 114 as unactionable. Actionable feedbacks may usually have neutral sentiments. If the sentences in feedback 114 with the overlapping predicate-object pairs are not classified as neutral using sentiment analysis, performance assessment analytics 110 may mark feedback 114 as unactionable. If the neutral sentences in feedback 114 with overlapping predicate-object pairs do not contain a<helping verb, verb> pair from the pre-curated list of actions for a role, performance assessment analytics 110 may mark feedback 114 as unactionable. Otherwise, performance assessment analytics 110 may mark feedback 114 as actionable.

In one or more embodiments, performance assessment analytics 110 is configured to classify one or more feedbacks 114 as consistent or inconsistent with the corresponding dimension of goal 112. Performance assessment analytics 110 may train a document classification model with inputs of feedbacks 114 and dimensions of goals 112, where every pre-specified dimension becomes a class label and historically accepted and validated feedbacks 114 against that dimension become the training set. Performance assessment analytics 110 may use the trained document classification model to classify the given feedback 114 into one of the pre-specified dimensions. If the assigned dimension label is same as the dimension of goal 112, performance assessment analytics 110 may mark the feedback 114 as consistent with the goal dimension. Otherwise, performance assessment analytics 110 may mark the feedback 114 as inconsistent.

In one or more embodiments, performance assessment analytics 110 is configured to classify one or more feedbacks 114 as consistent or inconsistent with the corresponding position level of the employee. Performance assessment analytics 110 may mark the feedback 114 as inconsistent with the position level of the employee if the feedback 114 is not actionable or the feedback is not consistent with the goal dimension. Performance assessment analytics 110 may train an intent identification model separately for every job role, where a responsibility becomes an intent and historically accepted and validated feedbacks 114 against that responsibility become the training text. Performance assessment analytics 110 may extract all the responsibilities (intents) from job role requirements for the employee's role in the organization, for example, using a simple lookup. Performance assessment analytics 110 may classify the given feedback 114 into one of the intents using the trained intent identification model. If the intent of the feedback 114 matches with one of the responsibilities (intents) of the employee's role, performance assessment analytics 110 may mark the feedback 114 as consistent with the position level of the employee. Otherwise, performance assessment analytics 110 may mark the feedback 114 as inconsistent. Performance assessment analytics 110 may continuously monitor feedbacks 114 provided by managers 103 and may raise alerts whenever an unactionable feedback is provided for employee 101. For example, performance assessment analytics 110 may notify manager 103 to consider improving a feedback if the feedback is classified as unactionable. Performance assessment analytics 110 may provide detailed analysis to manager 103 why the feedback is unactionable. Performance assessment analytics 110 may notify manager 103 to consider improving a feedback if the feedback is classified as inconsistent with the assessment dimension or the feedback is classified as not suitable for the position level of employee 101.

In one or more embodiments, performance assessment analytics 110 is configured to convert one or more feedbacks 114 along the corresponding dimension into a rating for the dimension on a pre-defined scale. The rating scale may be pre-specified by an organization. Performance assessment analytics 110 may combine all feedbacks 114 along a dimension to form a document. Performance assessment analytics 110 may count the number of sentences with positive, neutral, and negative sentiments. Performance assessment analytics 110 may extract sentiments using a sentiment analysis. Performance assessment analytics 110 may calculate percentages of positive, neutral, and negative sentiments. Performance assessment analytics 110 may train a document classification model for every dimension and every job role, where every rating becomes a class label and documents formed using historically consistent and actionable feedbacks against that rating become the training set. Performance assessment analytics 110 may consider the counts and percentages as additional features for training the document classification model. Performance assessment analytics 110 may use the trained document classification model to classify the document, which is formed using the given feedbacks, into one of the ratings. In an example, manager 103 may provide a rating to employee 101 along the dimension. If the rating estimated based on the periodic feedbacks is not consistent as the rating provided by manager 103, performance assessment analytics 110 may notify manager 103 to consider updating the feedback comments or revising the rating.

In one or more embodiments, performance assessment analytics 110 is configured to calculate an engagement score within a team based on the quality of goals 112 provided by the team and the quality of feedbacks 114 provided by manager 103. Performance assessment analytics 110 may monitor the overall engagement with the team based on the engagement score and may raise alerts to human resource manager or higher authority 105 whenever the engagement score falls below a threshold. Performance assessment analytics 110 may calculate the engagement score based on a relevancy score for the goal, a dimension consistency score for the goal, an actionability score for the feedback, a dimension consistency score for the feedback, and a position level consistency score for the feedback. In an example, performance assessment analytics 110 may take as inputs of all the goal-feedback pairs from a team with relevancy score (denoted as α) for goals 112, dimension consistency score (denoted as β) for goals 112, actionability score (denoted as γ) for feedbacks 114, dimension consistency score (denoted as δ) for feedbacks 114, and position level consistency score (denoted as η) for feedbacks 114. The range of each score can be defined between 0 and 1. The higher score, the better. For each goal-feedback pair, the corresponding engagement score may be calculated as:

$$\frac{( {α}_{G} \times {β}_{G} ) + ( {γ}_{F} \times {δ}_{F} \times {η}_{F} )}{2}$$

The overall engagement score for the team can be calculated as the sum of each corresponding engagement score divided by the number (n) of goal-feedback pairs from the team:

$$engagement score = \frac{sum}{n} .$$

In an example, after every goal-feedback cycle and despite several notifications to employees 101 of a team and/or manager 103 of the team, if quality of goals 112 and/or feedbacks 114 has not improved, performance assessment analytics 110 may alert human resource manager or higher authority 105 for intervention.

Further, in the depicted embodiment, performance assessment analytics 110 includes goal analyzer 116, feedback analyzer 118, and team engagement analyzer 120. In the depicted embodiment, goal analyzer 116, feedback analyzer 118, and team engagement analyzer 120 are located on computing device 102 and performance assessment analytics 110. However, in other embodiments, goal analyzer 116, feedback analyzer 118, and team engagement analyzer 120 may be located externally and accessed through a communication network such as network 108.

In one or more embodiments, goal analyzer 116 is configured to classify every goal 112 submitted by employee 101 as relevant or irrelevant, based on an analysis of employee profiles 124, projects 122, job role requirements 126, and a position level associated with employee 101. Goal analyzer 116 may analyze employee profiles 124, the employee's team projects 122, job role requirements 126, and the position level of employee 101 to classify every goal 112, which employee 101 provides into an assessment tool, as relevant or irrelevant. Goal analyzer 116 may train an intent identification model separately for every job role with inputs of goals 112, employee's roles, job role requirements 126, and employee's details of projects 122, wherein a responsibility becomes an intent and historically accepted and validated goals 112 against that responsibility become the training text. Goal analyzer 116 may extract all the named entities from employee's project details using a named-entity recognition algorithm. Goal analyzer 116 may extract all the intents from job role requirements 126 for the employee's role in the organization. Goal analyzer 116 may classify given goal 112 into one of the intents using the trained intent identification model. Goal analyzer 116 may extract named entities from given goal 112. Goal analyzer 116 mark goal 112 as relevant, in response to the intent of goal 112 matching with one of the intents of the employee's role and at least one named entity in goal 112 belonging to the project entities.

In one or more embodiments, goal analyzer 116 is configured to classify every goal 112 into one of the pre-defined dimensions. For example, the pre-defined dimensions can be business results, client success, innovation, responsibility to others, skills, or other suitable dimensions which can be defined by an organization. Goal analyzer 116 may train a document classification model with inputs of goals 112 and pre-specified dimensions, where every pre-specified dimension becomes a class label and historically accepted and validated goals 112 against that dimension become the training set. Goal analyzer 116 may use the trained document classification model to classify the given goal 112 into one of the pre-specified dimensions. Goal analyzer 116 may continuously monitor goals 112 provided by employees 101 and may raise alerts whenever an inconsistent goal is set with respect to the employee job role and position level. For example, if goal analyzer 116 classifies a goal as inconsistent with the job role, responsibilities, position level, team projects or the assessment dimension, goal analyzer 116 may notify employee 101 to consider removing or modifying the goal.

In one or more embodiments, feedback analyzer 118 is configured to receive one or more feedbacks 114 about employee 101 from manager 103. Feedback analyzer 118 may classify one or more feedbacks 114 as actionable or unactionable with respect to corresponding goal 112. Feedback analyzer 118 may mark a given feedback 114 as unactionable if feedback 114 is missing or empty. Feedback analyzer 118 may use a natural language processing library (e.g., a natural language toolkit in Python®) to check if proper sentences are written. If feedback 114 is just a set of small phrases, performance assessment analytics 110 may mark feedback 114 as unactionable. Feedback analyzer 118 may extract predicate-object pairs from goal 112 and feedback 114 using part of speech tagging. If there is no overlap among pairs from goal 112 and feedback 114, feedback analyzer 118 may indicate that feedback 114 is not relevant and may mark feedback 114 as unactionable. Actionable feedbacks may usually have neutral sentiments. If the sentences in feedback 114 with the overlapping predicate-object pairs are not classified as neutral using sentiment analysis, feedback analyzer 118 may mark feedback 114 as unactionable. If the neutral sentences in feedback 114 with overlapping predicate-object pairs do not contain a<helping verb, verb> pair from the pre-curated list of actions for a role, feedback analyzer 118 may mark feedback 114 as unactionable. Otherwise, feedback analyzer 118 may mark feedback 114 as actionable.

In one or more embodiments, feedback analyzer 118 is configured to classify one or more feedbacks 114 as consistent or inconsistent with the corresponding dimension of goal 112. Feedback analyzer 118 may train a document classification model with inputs of feedbacks 114 and dimensions of goals 112, where every pre-specified dimension becomes a class label and historically accepted and validated feedbacks 114 against that dimension become the training set. Feedback analyzer 118 may use the trained document classification model to classify the given feedback 114 into one of the pre-specified dimensions. If the assigned dimension label is same as the dimension of goal 112, feedback analyzer 118 may mark the feedback 114 as consistent with the goal dimension. Otherwise, feedback analyzer 118 may mark the feedback 114 as inconsistent.

In one or more embodiments, feedback analyzer 118 is configured to classify one or more feedbacks 114 as consistent or inconsistent with the corresponding position level of the employee. Feedback analyzer 118 may mark the feedback 114 as inconsistent with the position level of the employee if the feedback 114 is not actionable or the feedback is not consistent with the goal dimension. Feedback analyzer 118 may train an intent identification model separately for every job role, where a responsibility becomes an intent and historically accepted and validated feedbacks 114 against that responsibility become the training text. Feedback analyzer 118 may extract all the responsibilities (intents) from job role requirements for the employee's role in the organization, for example, using a simple lookup. Feedback analyzer 118 may classify the given feedback 114 into one of the intents using the trained intent identification model. If the intent of the feedback 114 matches with one of the responsibilities (intents) of the employee's role, feedback analyzer 118 may mark the feedback 114 as consistent with the position level of the employee. Otherwise, feedback analyzer 118 may mark the feedback 114 as inconsistent. Feedback analyzer 118 may continuously monitor feedbacks 114 provided by managers 103 and may raise alerts whenever an unactionable feedback is provided for employee 101. For example, feedback analyzer 118 may notify manager 103 to consider improving a feedback if the feedback is classified as unactionable. Feedback analyzer 118 may provide detailed analysis to manager 103 why the feedback is unactionable. Feedback analyzer 118 may notify manager 103 to consider improving a feedback if the feedback is classified as inconsistent with the assessment dimension or the feedback is classified as not suitable for the position level of employee 101.

In one or more embodiments, feedback analyzer 118 is configured to convert one or more feedbacks 114 along the corresponding dimension into a rating for the dimension on a pre-defined scale. The rating scale may be pre-specified by an organization. Feedback analyzer 118 may combine all feedbacks 114 along a dimension to form a document. Feedback analyzer 118 may count the number of sentences with positive, neutral, and negative sentiments. Feedback analyzer 118 may extract sentiments using a sentiment analysis. Feedback analyzer 118 may calculate percentages of positive, neutral, and negative sentiments. Feedback analyzer 118 may train a document classification model for every dimension and every job role, where every rating becomes a class label and documents formed using historically consistent and actionable feedbacks against that rating become the training set. Feedback analyzer 118 may consider the counts and percentages as additional features for training the document classification model. Feedback analyzer 118 may use the trained document classification model to classify the document, which is formed using the given feedbacks, into one of the ratings. In an example, manager 103 may provide a rating to employee 101 along the dimension. If the rating estimated based on the periodic feedbacks is not consistent as the rating provided by manager 103, feedback analyzer 118 may notify manager 103 to consider updating the feedback comments or revising the rating.

In one or more embodiments, team engagement analyzer 120 is configured to calculate an engagement score within a team based on the quality of goals 112 provided by the team and the quality of feedbacks 114 provided by manager 103. Team engagement analyzer 120 may monitor the overall engagement with the team based on the engagement score and may raise alerts to human resource manager or higher authority 105 whenever the engagement score falls below a threshold. Team engagement analyzer 120 may calculate the engagement score based on a relevancy score for the goal, a dimension consistency score for the goal, an actionability score for the feedback, a dimension consistency score for the feedback, and a position level consistency score for the feedback. In an example, team engagement analyzer 120 may take as inputs of all the goal-feedback pairs from a team with relevancy score (denoted as α) for goals 112, dimension consistency score (denoted as β) for goals 112, actionability score (denoted as γ) for feedbacks 114, dimension consistency score (denoted as δ) for feedbacks 114, and position level consistency score (denoted as η) for feedbacks 114. The range of each score can be defined between 0 and 1. The higher score, the better. For each goal-feedback pair, the corresponding engagement score may be calculated as:

$$\frac{( {α}_{G} \times {β}_{G} ) + ( {γ}_{F} \times {δ}_{F} \times {η}_{F} )}{2}$$

The overall engagement score for the team can be calculated as the sum of each corresponding engagement score divided by the number (n) of goal-feedback pairs from the team:

$$engagement score = \frac{sum}{n} .$$

after every goal-feedback cycle and despite several notifications to employees 101 of a team and/or manager 103 of the team, if quality of goals 112 and/or feedbacks 114 has not improved, team engagement analyzer 120 may alert human resource manager or higher authority 105 for intervention.

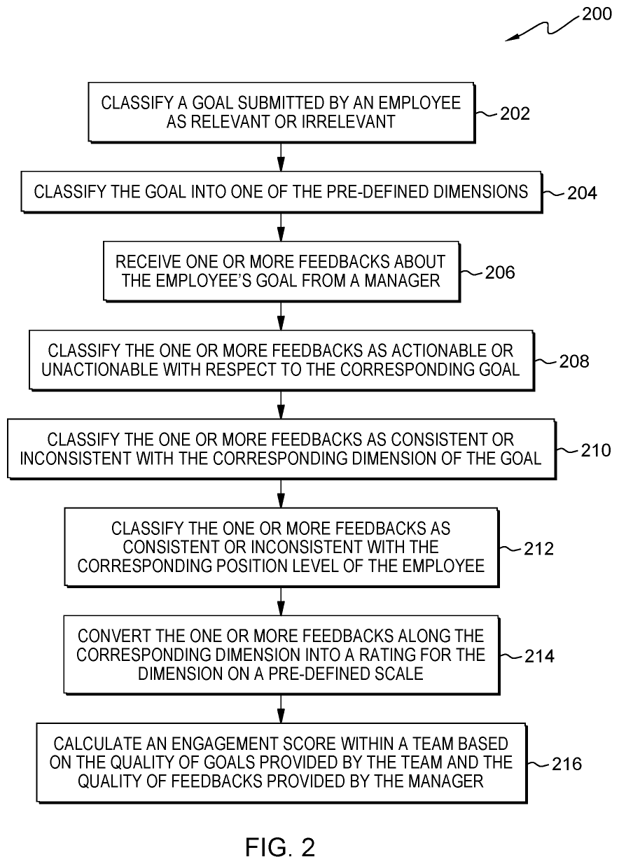

FIG. 2 is a flowchart 200 depicting operational steps of performance assessment analytics 110 in accordance with an embodiment of the present disclosure.

Performance assessment analytics 110 operates to classify every goal 112 submitted by employee 101 as relevant or irrelevant, based on an analysis of employee profiles 124, projects 122, job role requirements 126, and a position level associated with employee 101. Performance assessment analytics 110 also operates to classify every goal 112 into one of the pre-defined dimensions. Performance assessment analytics 110 operates to receive one or more feedbacks 114 about employee 101 from manager 103. Performance assessment analytics 110 operates to classify one or more feedbacks 114 as actionable or unactionable with respect to corresponding goal 112. Performance assessment analytics 110 operates to classify one or more feedbacks 114 as consistent or inconsistent with the corresponding dimension of goal 112. Performance assessment analytics 110 operates to classify one or more feedbacks 114 as consistent or inconsistent with the corresponding position level of the employee. Performance assessment analytics 110 operates to convert one or more feedbacks 114 along the corresponding dimension into a rating for the dimension on a pre-defined scale. Performance assessment analytics 110 operates to calculate an engagement score within a team based on the quality of goals 112 provided by the team and the quality of feedbacks 114 provided by manager 103.

In step 202, performance assessment analytics 110 classifies goal 112 submitted by employee 101 as relevant or irrelevant, based on an analysis of employee profiles 124, projects 122, job role requirements 126, and a position level associated with employee 101. Performance assessment analytics 110 may analyze employee profiles 124, the employee's team projects 122, job role requirements 126, and the position level of employee 101 to classify every goal 112, which employee 101 provides into an assessment tool, as relevant or irrelevant. Performance assessment analytics 110 may train an intent identification model separately for every job role with inputs of goals 112, employee's roles, job role requirements 126, and employee's details of projects 122, wherein a responsibility becomes an intent and historically accepted and validated goals 112 against that responsibility become the training text. Performance assessment analytics 110 may extract all the named entities from employee's project details using a named-entity recognition algorithm. Performance assessment analytics 110 may extract all the intents from job role requirements 126 for the employee's role in the organization. Performance assessment analytics 110 may classify given goal 112 into one of the intents using the trained intent identification model. Performance assessment analytics 110 may extract named entities from given goal 112. Performance assessment analytics 110 may mark goal 112 as relevant, in response to the intent of goal 112 matching with one of the intents of the employee's role and at least one named entity in goal 112 belonging to the project entities.

In step 204, performance assessment analytics 110 classifies every goal 112 into one of the pre-defined dimensions. For example, the pre-defined dimensions can be business results, client success, innovation, responsibility to others, skills, or other suitable dimensions which can be defined by an organization. Performance assessment analytics 110 may train a document classification model with inputs of goals 112 and pre-specified dimensions, where every pre-specified dimension becomes a class label and historically accepted and validated goals 112 against that dimension become the training set. Performance assessment analytics 110 may use the trained document classification model to classify the given goal 112 into one of the pre-specified dimensions. Performance assessment analytics 110 may continuously monitor goals 112 provided by employees 101 and may raise alerts whenever an inconsistent goal is set with respect to the employee job role and position level. For example, if performance assessment analytics 110 classifies a goal as inconsistent with the job role, responsibilities, position level, team projects or the assessment dimension, performance assessment analytics 110 may notify employee 101 to consider removing or modifying the goal.

In step 206, performance assessment analytics 110 receives one or more feedbacks 114 about employee 101 from manager 103. In step 208, performance assessment analytics 110 classifies one or more feedbacks 114 as actionable or unactionable with respect to corresponding goal 112. Performance assessment analytics 110 may mark a given feedback 114 as unactionable if feedback 114 is missing or empty. Performance assessment analytics 110 may use a natural language processing library (e.g., a natural language toolkit in Python) to check if proper sentences are written. If feedback 114 is just a set of small phrases, performance assessment analytics 110 may mark feedback 114 as unactionable. Performance assessment analytics 110 may extract predicate-object pairs from goal 112 and feedback 114 using part of speech tagging. If there is no overlap among pairs from goal 112 and feedback 114, performance assessment analytics 110 may indicate that feedback 114 is not relevant and may mark feedback 114 as unactionable. Actionable feedbacks may usually have neutral sentiments. If the sentences in feedback 114 with the overlapping predicate-object pairs are not classified as neutral using sentiment analysis, performance assessment analytics 110 may mark feedback 114 as unactionable. If the neutral sentences in feedback 114 with overlapping predicate-object pairs do not contain a<helping verb, verb> pair from the pre-curated list of actions for a role, performance assessment analytics 110 may mark feedback 114 as unactionable. Otherwise, performance assessment analytics 110 may mark feedback 114 as actionable.

In step 210, performance assessment analytics 110 classifies one or more feedbacks 114 as consistent or inconsistent with the corresponding dimension of goal 112. Performance assessment analytics 110 may train a document classification model with inputs of feedbacks 114 and dimensions of goals 112, where every pre-specified dimension becomes a class label and historically accepted and validated feedbacks 114 against that dimension become the training set. Performance assessment analytics 110 may use the trained document classification model to classify the given feedback 114 into one of the pre-specified dimensions. If the assigned dimension label is same as the dimension of goal 112, performance assessment analytics 110 may mark the feedback 114 as consistent with the goal dimension. Otherwise, performance assessment analytics 110 may mark the feedback 114 as inconsistent.

In step 212, performance assessment analytics 110 classifies one or more feedbacks 114 as consistent or inconsistent with the corresponding position level of the employee. Performance assessment analytics 110 may mark the feedback 114 as inconsistent with the position level of the employee if the feedback 114 is not actionable or the feedback is not consistent with the goal dimension. Performance assessment analytics 110 may train an intent identification model separately for every job role, where a responsibility becomes an intent and historically accepted and validated feedbacks 114 against that responsibility become the training text. Performance assessment analytics 110 may extract all the responsibilities (intents) from job role requirements for the employee's role in the organization, for example, using a simple lookup. Performance assessment analytics 110 may classify the given feedback 114 into one of the intents using the trained intent identification model. If the intent of the feedback 114 matches with one of the responsibilities (intents) of the employee's role, performance assessment analytics 110 may mark the feedback 114 as consistent with the position level of the employee. Otherwise, performance assessment analytics 110 may mark the feedback 114 as inconsistent. Performance assessment analytics 110 may continuously monitor feedbacks 114 provided by managers 103 and may raise alerts whenever an unactionable feedback is provided for employee 101. For example, performance assessment analytics 110 may notify manager 103 to consider improving a feedback if the feedback is classified as unactionable. Performance assessment analytics 110 may provide detailed analysis to manager 103 why the feedback is unactionable. Performance assessment analytics 110 may notify manager 103 to consider improving a feedback if the feedback is classified as inconsistent with the assessment dimension or the feedback is classified as not suitable for the position level of employee 101.

In step 214, performance assessment analytics 110 converts one or more feedbacks 114 along the corresponding dimension into a rating for the dimension on a pre-defined scale. The rating scale may be pre-specified by an organization. Performance assessment analytics 110 may combine all feedbacks 114 along a dimension to form a document. Performance assessment analytics 110 may count the number of sentences with positive, neutral, and negative sentiments. Performance assessment analytics 110 may extract sentiments using a sentiment analysis. Performance assessment analytics 110 may calculate percentages of positive, neutral, and negative sentiments. Performance assessment analytics 110 may train a document classification model for every dimension and every job role, where every rating becomes a class label and documents formed using historically consistent and actionable feedbacks against that rating become the training set. Performance assessment analytics 110 may consider the counts and percentages as additional features for training the document classification model. Performance assessment analytics 110 may use the trained document classification model to classify the document, which is formed using the given feedbacks, into one of the ratings. In an example, manager 103 may provide a rating to employee 101 along the dimension. If the rating estimated based on the periodic feedbacks is not consistent as the rating provided by manager 103, performance assessment analytics 110 may notify manager 103 to consider updating the feedback comments or revising the rating.

In step 216, performance assessment analytics 110 calculates an engagement score within a team based on the quality of goals 112 provided by the team and the quality of feedbacks 114 provided by manager 103. Performance assessment analytics 110 may monitor the overall engagement with the team based on the engagement score and may raise alerts to human resource manager or higher authority 105 whenever the engagement score falls below a threshold. Performance assessment analytics 110 may calculate the engagement score based on a relevancy score for the goal, a dimension consistency score for the goal, an actionability score for the feedback, a dimension consistency score for the feedback, and a position level consistency score for the feedback. In an example, performance assessment analytics 110 may take as inputs of all the goal-feedback pairs from a team with relevancy score (denoted as α) for goals 112, dimension consistency score (denoted as β) for goals 112, actionability score (denoted as γ) for feedbacks 114, dimension consistency score (denoted as δ) for feedbacks 114, and position level consistency score (denoted as η) for feedbacks 114. The range of each score can be defined between 0 and 1. The higher score, the better. For each goal-feedback pair, the corresponding engagement score may be calculated as:

$$\frac{( {α}_{G} \times {β}_{G} ) + ( {γ}_{F} \times {δ}_{F} \times {η}_{F} )}{2}$$

The overall engagement score for the team can be calculated as the sum of each corresponding engagement score divided by the number (n) of goal-feedback pairs from the team: engagement

$$engagement score = \frac{sum}{n} .$$

in an example, after every goal-feedback cycle and despite several notifications to employees 101 of a team and/or manager 103 of the team, if quality of goals 112 and/or feedbacks 114 has not improved, performance assessment analytics 110 may alert human resource manager or higher authority 105 for intervention.

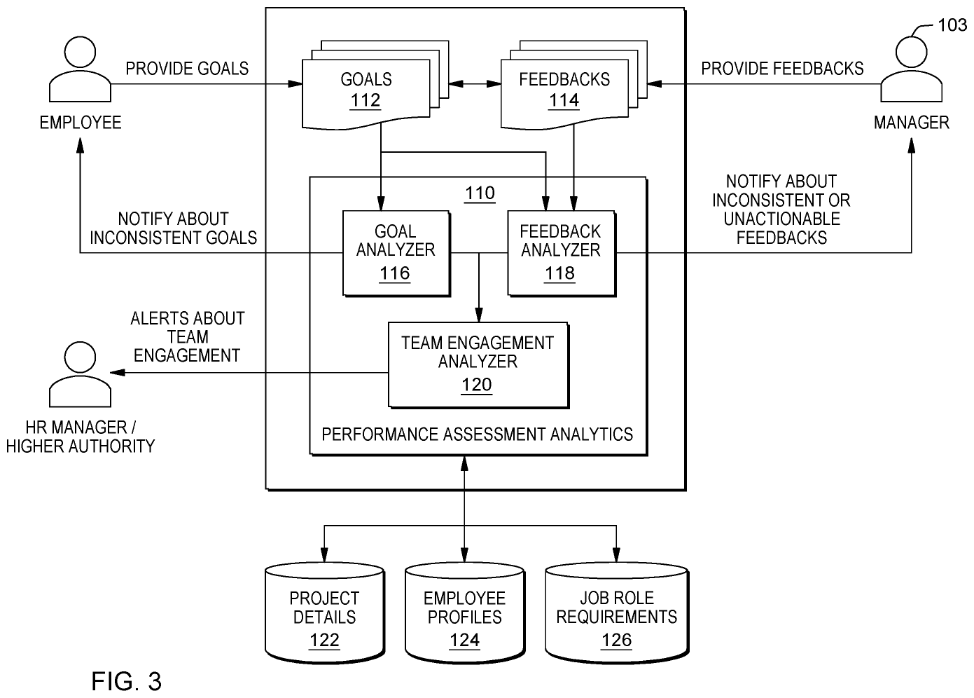

FIG. 3 illustrates an exemplary functional diagram of performance assessment analytics 110 in accordance with an embodiment of the present disclosure.

In the example of FIG. 3, employee 101 may provide goals 112. Manager 103 may provide feedbacks 114 for employee 101. Performance assessment analytics 110 includes goal analyzer 116, feedback analyzer 118, and team engagement analyzer 120. Performance assessment analytics 110 may take as inputs of employee projects 122, profiles 124, and job role requirements 126 to classify goals 112 and feedbacks 114. In an example, if performance assessment analytics 110 determines goals 112 as inconsistent with the job role, responsibilities, position level, team projects or the assessment dimension, performance assessment analytics 110 may notify employee 101 to consider removing or modifying the goal. In another example, performance assessment analytics 110 may notify manager 103 to consider improving a feedback if the feedback is classified as unactionable. Performance assessment analytics 110 may notify manager 103 to consider improving a feedback if the feedback is classified as inconsistent with the assessment dimension or the feedback is classified as not suitable for the position level of employee 101. In an example, after every goal-feedback cycle and despite several notifications to employees 101 of a team and/or manager 103 of the team, if quality of goals 112 and/or feedbacks 114 has not improved, performance assessment analytics 110 may alert human resource manager or higher authority 105 about the team engagement.

FIG. 4 depicts a block diagram 400 of components of computing device 102 in accordance with an illustrative embodiment of the present disclosure. It should be appreciated that FIG. 4 provides only an illustration of one implementation and does not imply any limitations with regard to the environments in which different embodiments may be implemented. Many modifications to the depicted environment may be made.

Computing device 102 may include communications fabric 402, which provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Performance assessment analytics 110 may be stored in persistent storage 408 and in memory 406 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Performance assessment analytics 110 may be downloaded to persistent storage 408 through communications unit 410.

I/O interface(s) 412 allows for input and output of data with other devices that may be connected to computing device 102. For example, I/O interface 412 may provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., performance assessment analytics 110 can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method comprising:
classifying, by one or more processors, relevancy of a goal submitted by an employee, based on an analysis of an employee profile, one or more team projects, one or more job role responsibilities, and a position level associated with the employee;
classifying, by one or more processors, the goal into one of pre-defined dimensions;
receiving, by one or more processors, feedback about the goal from a manager;
classifying, by one or more processors, whether the feedback is actionable with respect to the corresponding goal;
classifying, by one or more processors, consistency of the feedback with the corresponding dimension of the goal;
classifying, by one or more processors, consistency of the feedback with the corresponding position level of the employee; and
converting, by one or more processors, the feedback along the corresponding dimension into a rating for the dimension on a pre-defined scale.

2. The computer-implemented method of claim 1, further comprising:
calculating, by one or more processors, an engagement score within a team based on the quality of goals provided by the team and the quality of feedback provided by the manager, wherein the engagement score is calculated based on a relevancy score for the goal, a dimension consistency score for the goal, an actionability score for the feedback, a dimension consistency score for the feedback, and a position level consistency score for the feedback.

3. The computer-implemented method of claim 1, wherein classifying the relevancy of the goal submitted by an employee comprises:
training an intent identification model separately for a job role, wherein a responsibility becomes an intent and historically accepted and validated goals against that responsibility become the training text;
extracting the named entities from employee's project details using a named-entity recognition algorithm;
extracting the intents from job role requirements for the employee's role in the organization;
classifying the given goal into one of the intents using the trained intent identification model;
extracting named entities from the given goal; and
in response to the intent of the goal matching with one of the intents of the employee's role and at least one named entity in the goal belonging to the project entities, marking the goal as relevant.

4. The computer-implemented method of claim 1, wherein classifying the goal into one of the pre-defined dimensions comprises:
training a document classification model, wherein every pre-specified dimension becomes a class label and historically accepted and validated goals against that dimension become the training set; and
using the trained document classification model to classify the given goal into one of the pre-specified dimensions.

5. The computer-implemented method of claim 1, wherein classifying whether the feedback is actionable with respect to the corresponding goal comprises:
in response that the feedback is missing or empty, marking the feedback as unactionable;
checking whether proper sentences are written, using a natural language processing library;
in response that the feedback is of a number of words below a threshold, marking the feedback as unactionable;
extracting a predicate-object pair from the goal and the feedback using part of speech tagging;
in response that there is no overlap among the pair from the goal and the feedback, marking the feedback as unactionable;
in response that the sentences in the feedback with the overlapping predicate-object pairs are not classified as neutral using a sentiment analysis, marking the feedback as unactionable; and
in response that the neutral sentences in the feedback with overlapping predicate-object pairs do not contain a helping verb and verb pair from the pre-curated list of actions for the role, marking the feedback as unactionable.

6. The computer-implemented method of claim 1, wherein classifying consistency of the feedback with the corresponding dimension of the goal comprises:
training a document classification model, wherein a pre-specified dimension becomes a class label and historically accepted and validated feedbacks against that dimension become the training set;
using the trained document classification model to classify the given feedback into one of the pre-specified dimensions; and
in response that the assigned dimension label is same as the dimension of the goal, marking the feedback as consistent with the goal dimension.

7. The computer-implemented method of claim 1, wherein classifying consistency of the feedback with the corresponding position level of the employee comprises:
training an intent identification model separately for a job role, where a responsibility becomes an intent and historically accepted and validated feedbacks against that responsibility become training text;
extracting the responsibilities from job role requirements for the employee's role in the organization;
classifying the given feedback into one of the intents using the trained intent identification model; and
in response that the intent of the feedback matches with one of the responsibilities of the employee's role, marking the feedback as consistent with the position level of the employee.

8. The computer-implemented method of claim 1, wherein converting the feedback along the corresponding dimension into a rating for the dimension on a pre-defined scale comprises:
combining feedback along a dimension to form a document;
counting number of sentences with positive, neutral, and negative sentiments;
extracting sentiments using sentiment analysis;
calculating percentages of positive, neutral, and negative sentiments;
training a document classification model for dimension and job role, wherein rating becomes a class label and documents formed using historically consistent and actionable feedbacks against that rating become the training set; and
using the trained document classification model to classify the document, which is formed using the given feedbacks, into one of the ratings.

9. A computer program product comprising:
one or more computer readable storage media, and program instructions collectively stored on the one or more computer readable storage media, the program instructions comprising:
program instructions to classify relevancy of a goal submitted by an employee, based on an analysis of an employee profile, one or more team projects, one or more job role responsibilities, and a position level associated with the employee;
program instructions to classify the goal into one of pre-defined dimensions;
program instructions to receive feedback about the goal from a manager;
program instructions to classify whether the feedback is actionable with respect to the corresponding goal;
program instructions to classify consistency of the feedback with the corresponding dimension of the goal;
program instructions to classify consistency of the feedback with the corresponding position level of the employee; and
program instructions to convert the feedback along the corresponding dimension into a rating for the dimension on a pre-defined scale.

10. The computer program product of claim 9, further comprising:
program instructions to calculate an engagement score within a team based on the quality of goals provided by the team and the quality of feedback provided by the manager, wherein the engagement score is calculated based on a relevancy score for the goal, a dimension consistency score for the goal, an actionability score for the feedback, a dimension consistency score for the feedback, and a position level consistency score for the feedback.

11. The computer program product of claim 9, wherein program instructions to classify the relevancy of the goal submitted by an employee comprise:
program instructions to train an intent identification model separately for a job role, wherein a responsibility becomes an intent and historically accepted and validated goals against that responsibility become the training text;
program instructions to extract the named entities from employee's project details using a named-entity recognition algorithm;
program instructions to extract the intents from job role requirements for the employee's role in the organization;
program instructions to classify the given goal into one of the intents using the trained intent identification model;
program instructions to extract named entities from the given goal; and
program instructions to, in response to the intent of the goal matching with one of the intents of the employee's role and at least one named entity in the goal belonging to the project entities, mark the goal as relevant.

12. The computer program product of claim 9, wherein program instructions to classify the goal into one of the pre-defined dimensions comprise:
program instructions to train a document classification model, wherein every pre-specified dimension becomes a class label and historically accepted and validated goals against that dimension become the training set; and
program instructions to use the trained document classification model to classify the given goal into one of the pre-specified dimensions.

13. The computer program product of claim 9, wherein program instructions to classify whether the feedback is actionable with respect to the corresponding goal comprise:
program instructions to, in response that the feedback is missing or empty, mark the feedback as unactionable;
program instructions to check whether proper sentences are written, using a natural language processing library;
program instructions to, in response that the feedback is of a number of words below a threshold, mark the feedback as unactionable;
program instructions to extract a predicate-object pair from the goal and the feedback using part of speech tagging;
program instructions to, in response that there is no overlap among the pair from the goal and the feedback, mark the feedback as unactionable;
program instructions to, in response that the sentences in the feedback with the overlapping predicate-object pairs are not classified as neutral using a sentiment analysis, mark the feedback as unactionable; and
program instructions to, in response that the neutral sentences in the feedback with overlapping predicate-object pairs do not contain a helping verb and verb pair from the pre-curated list of actions for the role, mark the feedback as unactionable.

14. The computer program product of claim 9, wherein program instructions to classify consistency of the feedback with the corresponding dimension of the goal comprise:
program instructions to train a document classification model, wherein a pre-specified dimension becomes a class label and historically accepted and validated feedbacks against that dimension become the training set;
program instructions to use the trained document classification model to classify the given feedback into one of the pre-specified dimensions; and
program instructions to, in response that the assigned dimension label is same as the dimension of the goal, mark the feedback as consistent with the goal dimension.

15. The computer program product of claim 9, wherein program instructions to classify consistency of the feedback with the corresponding position level of the employee comprise:
program instructions to train an intent identification model separately for a job role, where a responsibility becomes an intent and historically accepted and validated feedbacks against that responsibility become training text;
program instructions to extract the responsibilities from job role requirements for the employee's role in the organization;
program instructions to classify the given feedback into one of the intents using the trained intent identification model; and
program instructions to, in response that the intent of the feedback matches with one of the responsibilities of the employee's role, mark the feedback as consistent with the position level of the employee.

16. The computer program product of claim 9, wherein program instructions to convert the feedback along the corresponding dimension into a rating for the dimension on a pre-defined scale comprise:
program instructions to combine feedback along a dimension to form a document;
program instructions to count number of sentences with positive, neutral, and negative sentiments;
program instructions to extract sentiments using sentiment analysis;
program instructions to calculate percentages of positive, neutral, and negative sentiments;
program instructions to train a document classification model for dimension and job role, wherein rating becomes a class label and documents formed using historically consistent and actionable feedbacks against that rating become the training set; and
program instructions to use the trained document classification model to classify the document, which is formed using the given feedbacks, into one of the ratings.

17. A computer system comprising:
one or more computer processors, one or more computer readable storage media, and program instructions stored on the one or more computer readable storage media for execution by at least one of the one or more computer processors, the program instructions comprising:
program instructions to classify relevancy of a goal submitted by an employee, based on an analysis of an employee profile, one or more team projects, one or more job role responsibilities, and a position level associated with the employee;
program instructions to classify the goal into one of pre-defined dimensions;
program instructions to receive feedback about the goal from a manager;
program instructions to classify whether the feedback is actionable with respect to the corresponding goal;
program instructions to classify consistency of the feedback with the corresponding dimension of the goal;
program instructions to classify consistency of the feedback with the corresponding position level of the employee; and
program instructions to convert the feedback along the corresponding dimension into a rating for the dimension on a pre-defined scale.

18. The computer system of claim 17, further comprising:
program instructions to calculate an engagement score within a team based on the quality of goals provided by the team and the quality of feedback provided by the manager, wherein the engagement score is calculated based on a relevancy score for the goal, a dimension consistency score for the goal, an actionability score for the feedback, a dimension consistency score for the feedback, and a position level consistency score for the feedback.

19. The computer system of claim 17, wherein program instructions to classify the relevancy of the goal submitted by an employee comprise:
program instructions to train an intent identification model separately for a job role, wherein a responsibility becomes an intent and historically accepted and validated goals against that responsibility become the training text;
program instructions to extract the named entities from employee's project details using a named-entity recognition algorithm;
program instructions to extract the intents from job role requirements for the employee's role in the organization;
program instructions to classify the given goal into one of the intents using the trained intent identification model;
program instructions to extract named entities from the given goal; and
program instructions to, in response to the intent of the goal matching with one of the intents of the employee's role and at least one named entity in the goal belonging to the project entities, mark the goal as relevant.

20. The computer system of claim 17, wherein program instructions to classify the goal into one of the pre-defined dimensions comprise:
program instructions to train a document classification model, wherein every pre-specified dimension becomes a class label and historically accepted and validated goals against that dimension become the training set; and
program instructions to use the trained document classification model to classify the given goal into one of the pre-specified dimensions.
